(19) United States
(12) Patent Application Publication
(10) Pub. No.: US 2005/0159096 A1
(43) Pub. Date: Jul. 21, 2005

(54) Windshield heating air appliance

(76) Inventor: Dennis Z. Ouyang, Milpitas, CA (US)

Correspondence Address: Denis Zhu Ouyang, 225 S Pembrooke Dr., Shaumburg, IL, 60193, US

(21) Appl. No.: 10/761,504

(22) Filed: Jan. 20, 2004

(51) Int. Cl. B60S 1/54

(52) U.S. Cl. 454/122

(57) ABSTRACT

The windshield heating air appliance is designed to keep heated air in an isolated area referred to as the controlled windshield heating air space, which is formed by attaching the windshield heating air appliance edges to the windshield. The controlled windshield heating air space is less than 1% of the automobile passenger compartment; thus air in the controlled windshield heating air space can be quickly heated, and the windshield surface can be maintained at an optimal temperature to prevent fogging of the windshield and reduce the time to melt ice accumulated on the windshield.

### CROSS-REFERENCE TO RELATED APPLICATIONS

U.S. application Ser. No. 10/761,504 (Title: Windshield Heating Air Appliance)

References Cited

| | | | International |
|---|---|---|---|
| | Publication | | Patent |
| Patent Number | Date | Inventors | Classification |
| U.S. Pat. No. 4,786,783 | 1988-11-22 | Woodard; | H05B3/10 |
| | | Floyd E. | |
| U.S. Pat. No. 6,155,061 | 2000-12-05 | Davis, Jr., | F29B49/02 |
| | | et al. | |
| U.S. Pat. No. 6,598,653 | 2003-07-29 | Gonzalez | B60J1/20 |
| U.S. Pat. No. 6,668,917 | 2003-12-30 | Zeng; Xin | B60H1/00 |

### BACKGROUND OF THE INVENTION

1. Field of the Invention

The present invention is directed to devices designed to accomplish the following:
To prevent fogging of the automobile windshield.
To enhance thawing of ice accumulated on the automobile windshield.

2. Prior Art

Fogging is caused by condensed water vapor collecting on a glass surface due to the difference in temperature between the glass surface and the adjacent air. Warmer air inside an automobile in contact with the windshield will be cooled down, the cooling of this air reduces its ability to retain moisture, and thus the moisture that is released condenses on the inside of the windshield. There are two different climate conditions in which fogging of the windshield occur even though the automobile has a ventilation system. First, in a cold climate, it occurs when the temperature inside the automobile differs significantly from the temperature outside. Secondly, in a wet climate such as a rainy day, it occurs when humidity inside the automobile is very high, the rain and wind keep the windshield cooler than air inside the automobile. When fogging of the windshield occurs, it significantly reduces the driver's visibility through the windshield, greatly increases the risk of traffic accidents. To address this issue, U.S. Pat. No. 4,786,783 provides an electrically heated laminated windshield, and U.S. Pat. Nos. 6,668,917 and 6,155,061 provide advanced HVAC systems. For average automobiles, the electrically heated laminated windshield is very expensive to produce, maintain and operate. The advanced HVAC systems that reduce fogging of the windshield are also too expensive for average automobiles.

Also, in a cold climate, an automobile cannot be operated until ice accumulated on the windshield is melted and removed. To melt the ice, the time to preheat the automobile passenger compartment may be significant. To address this issue, U.S. Pat. No. 6,598,653 provides a windshield cover to prevent ice accumulating. However, the windshield cover is easily stolen; also, after its use, the iced windshield cover may not be stored right way.

Currently, there is not a simple, economic approach that can effectively address the safety concerns related to fogging of the windshield in a wet or cold climate. Also, there is not a simple, economic and effective way to quickly melt ice accumulated on the windshield in a cold climate. Therefore, it is the objective of this invention to create a simple and economic solution to address the above issues effectively so that the automobile industry will adapt the solution and make driving safer and easier in a wet or cold climate. The characteristics of this invention will become apparent in light of the present specification, including claims, and drawings.

### BRIEF SUMMARY OF THE INVENTION

It is an objective of this invention to prevent fogging of the windshield in a wet or cold climate and thereby to improve driving safety.

Another objective of this invention is to speed up the melting of ice accumulated on the windshield in a cold climate so that an automobile can be operated soon after its engine warmed up.

According to this invention, a windshield heating air appliance, dashboard air vents cover and flexible male and female connectors are made of transparent plastics. The windshield and windshield heating air appliance together create an isolated space adjacent to the internal windshield surface that can be quickly heated up through the heated air supply to prevent fogging of the windshield in a wet or cold climate and reduce the time required to melt the ice accumulated on the windshield in a cold climate.

This invention has the following major advantages:
It provides a single solution to address multiple issues, which includes preventing fogging of the windshield, and reducing the time to melt ice accumulated on the windshield.
The windshield heating air appliance is inexpensive.
It does not occupy automobile passenger compartment usable room.
Its installation is simple and easy.

### BRIEF DESCRIPTION OF THE SEVERAL VIEWS OF THE DRAWING

The foregoing summary and the following detailed description may be better understood when read in conjunction with the accompanying drawings. Various embodiments are shown for the purpose of illustrating the invention. It is understood, however, that this invention is not limited to the precise implementation shown.

FIG. 1 shows an external isometric view of the windshield heating air appliance with a female connector (1) and a rear view mirror base path (3).

FIG. 2 shows a passenger side isometric view of the windshield heating air appliance.

FIG. 3 shows the windshield represented by thin dashed lines (4) and the windshield heating air appliance together to create an isolated space.

FIG. 4 shows an external view of the dashboard windshield air vents (5) and its cover (6) with a flexible male connector (2A).

FIG. 5 shows an external view of the dashboard (7) equipped with a dashboard windshield heated air outlet (8).

FIG. 6 shows an external view of the dashboard windshield heated air outlet (8) attached with a flexible stand-alone male connector (2B).

FIG. 7 shows a partial windshield heating air appliance edge with female buttons (9) and its corresponding male buttons (10) attached to the windshield surface.

FIG. 8 shows the partial windshield heating air appliance edge attached to the windshield.

FIG. 9 shows a partial dashboard windshield air vents cover edge with female buttons (12) and its corresponding male buttons (13) attached to the dashboard surface.

FIG. 10 shows the partial dashboard windshield air vents cover edge attached to the dashboard.

FIG. 11 shows a view of the windshield heating air appliance comprised of two symmetric parts to facilitate shipping.

### DETAILED DESCRIPTION OF THE INVENTION

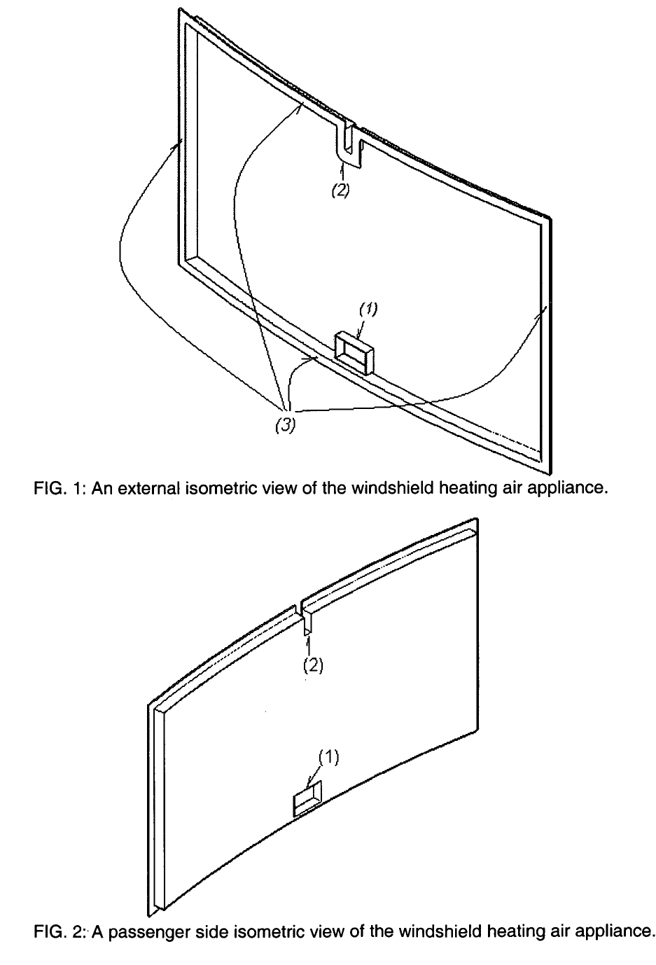

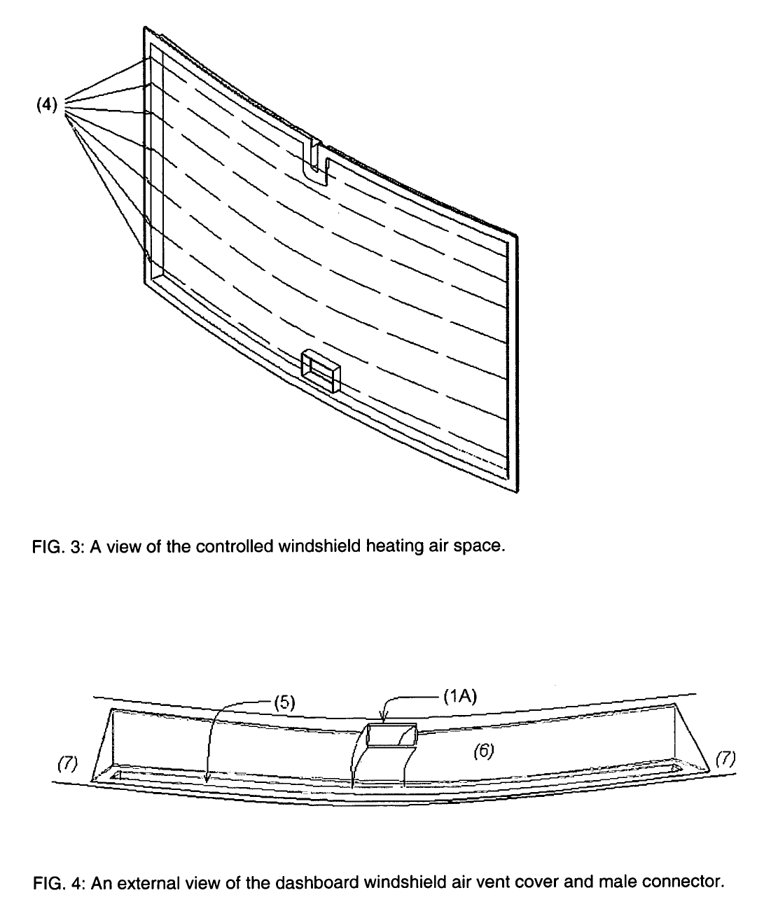

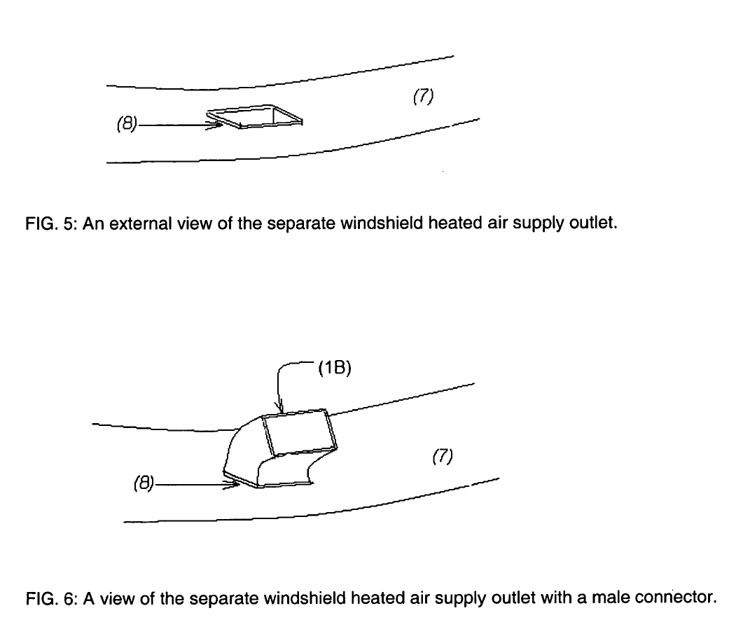

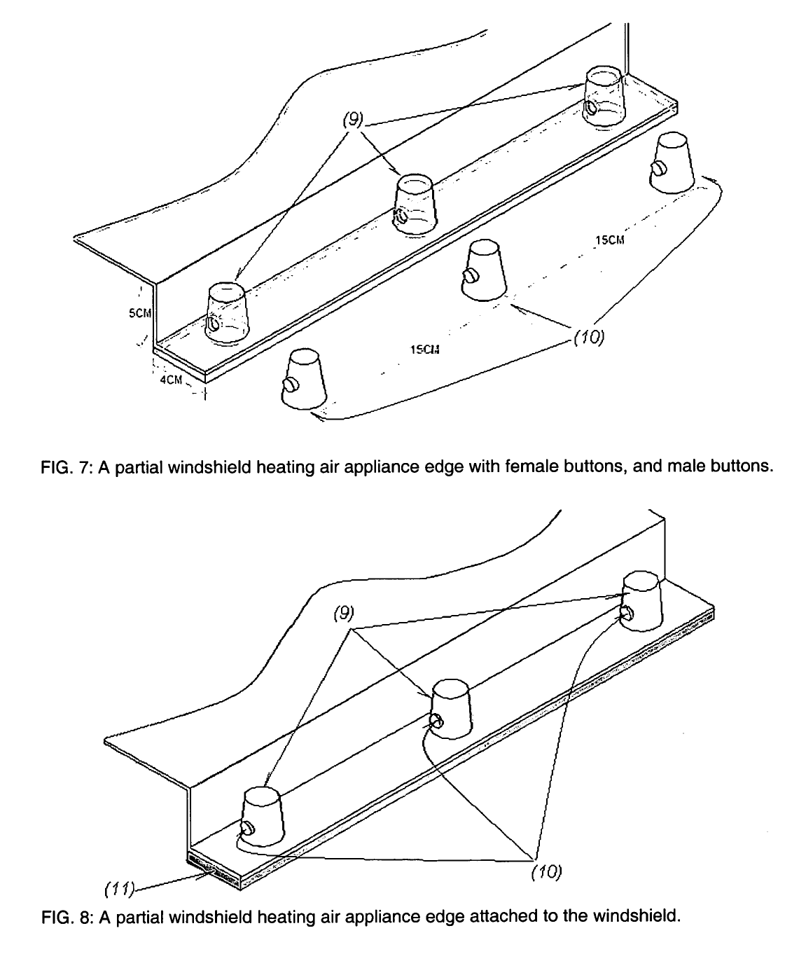

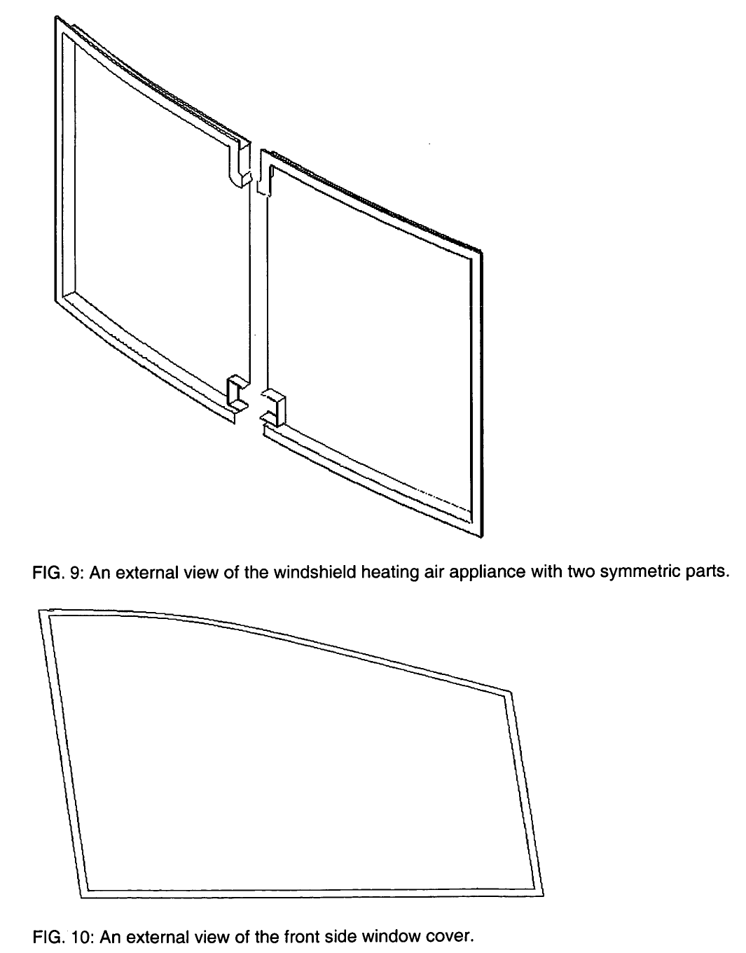

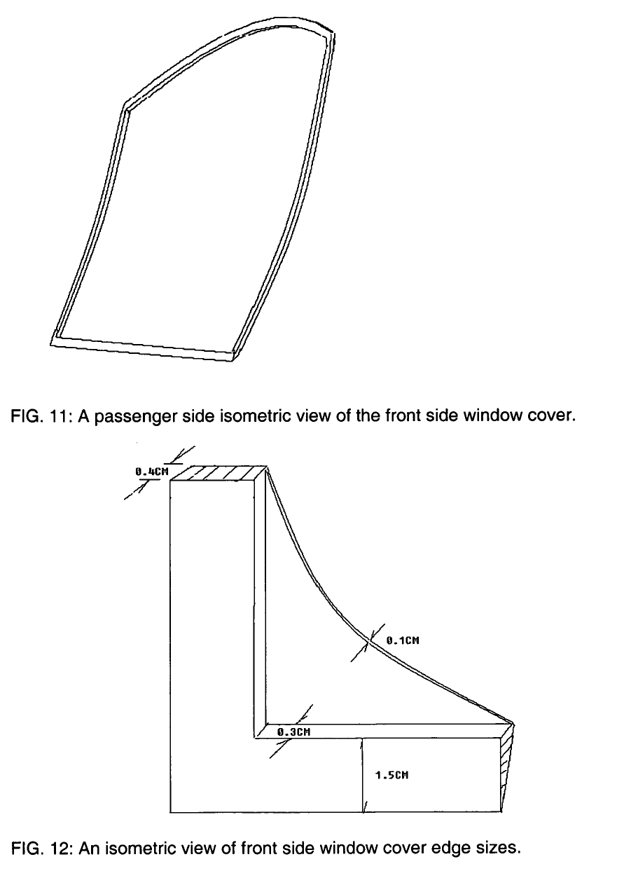

According to this invention, the windshield heating air appliance shown in FIG. 1 is attached to the windshield by locking its edge female buttons (9) with male buttons (10) that are fixed to the windshield surface. The foam layer (11) seals the gap between the windshield heating air appliance edges and the windshield surface, thus creates an isolated space henceforth referred as the controlled windshield heating air space, between the windshield heating air appliance and the windshield. Similarly, the dashboard windshield air vents cover (6) is attached to the dashboard surface (7) by locking its edge female buttons (12) with male buttons (13) that are fixed to the dashboard surface (7). The foam layer (11) seals the gap between the dashboard windshield air vents cover edges and the dashboard surface (7), to keep heated air supplied by the dashboard windshield air vents within the dashboard windshield air vents cover. Then the flexible male connector (2A) of the dashboard windshield air vents cover joins to the female connector (1) of the windshield heating air appliance, which assembles the windshield heating air appliance and the dashboard windshield air vents cover as a whole. Through a channel constructed by the dashboard windshield air vents cover (6) as well as the joint of the flexible male connector (2A) and female connector (1), heated air supplied by the dashboard windshield air vents (5) flows into the controlled windshield heating air space.

Alternatively, the dashboard windshield air vents (5) are replaced by the dashboard windshield heated air outlet (8) to reduce the dashboard windshield air vent cost. A flexible stand-alone male connector (2B) is attached to the dashboard windshield heated air outlet (8) to retain heated air. The flexible stand-alone male connector (2B) joins to the female connector (1) of the windshield heating air appliance, which assembles the windshield heating air appliance and the flexible stand-alone male connector (2B) as a whole. Through a channel constructed by the flexible stand-alone male connector (2B) as well as the joint of the flexible stand-alone male connector (2B) and female connector (1), heated air supplied by the dashboard windshield heated air outlet (8) flows into the controlled windshield heating air space.

The controlled windshield heating air space is less than 1% of the automobile passenger compartment; therefore, using heated air supplied by either dashboard windshield air vents (5) or a dashboard windshield heated air outlet (8), the controlled windshield heating air space can be quickly heated up, and the internal windshield surface can be maintained at an optimal temperature. As a result, the heated internal windshield surface no longer causes adjacent air to transfer moisture, which prevents fogging of the windshield, and ensures the best driving visibility in a wet or cold climate.

Furthermore, the controlled windshield heating air space can maintain the windshield surface at a relatively high temperature in a very cold climate, this can prevent the windshield from a dangerous “flash freeze” situation which may occur when water at or near freezing point strikes a relatively cool windshield while it is in motion, such as when cold water is splashed up onto a car windshield by a passing tractor-trailer.

According to this invention, the windshield heating air appliance is made of transparent materials such as plastics that will not be broken into pieces during an automobile crash. The dashboard windshield air vents cover (6) and flexible stand-alone male connector (2B) are also made of transparent materials.

When an automobile is parked in a parking lot or on the street in a cold climate, the normal practice to remove ice accumulated on the windshield is to preheat the automobile passenger compartment. Since the controlled windshield heating air space is less than 1% of an automobile passenger compartment, it takes much less time to heat up the controlled windshield heating air space compared to the entire automobile passenger compartment; thus it takes much a shorter time to heat up the windshield, melt ice accumulated on the windshield, and reduces pollution.

Some automobiles have the rear view mirror base attached to the ceiling. Others have the rear view mirror base attached to the windshield. To accommodate the need for the rear view mirror base attached to the windshield, the windshield heating air appliance has an open path (3) shown in FIG. 1 and FIG. 2 to fit the rear view mirror.

1. A windshield anti-fogging device comprising:
a windshield,
a windshield heating air appliance attached to said windshield through its edges to create a controlled windshield heating air space that retains heated air in an isolated room adjacent to said internal windshield surface to prevent fogging of said windshield and to enhance thawing of ice accumulated on said windshield,
dashboard windshield air vents that provide heated air,
a dashboard windshield air vents cover attached to said dashboard to retain the heated air supplied by said dashboard windshield air vents and,
a flexible male connector of said dashboard windshield air vents cover which joins to a female connector of said windshield heating air appliance to construct a channel that supply heated air from said dashboard windshield air vents to said controlled windshield heating air space.

2. An alternative windshield anti-fogging device comprising:
said windshield,
said windshield heating air appliance in accordance with claim 1,
a dashboard windshield heated air outlet that provides heated air,
a flexible stand-alone male connector attached to said dashboard windshield heated air outlet to retain the heated air supplied by said dashboard windshield heated air outlet and,
said flexible stand-alone male connector which joins to said female connector of said windshield heating air appliance to construct a channel that supply heated air from said dashboard windshield heated air outlet to said controlled windshield heating air space.

3. Said windshield heating air appliance in accordance with claim 1 is made of transparent plastics that will not be broken into pieces during an automobile crash.

4. Said dashboard windshield air vents cover in accordance with claim 1 and said flexible stand-alone male connector in accordance with claim 2 are made of transparent plastics.
